(19) United States
(12) Patent Application Publication
(10) Pub. No.: US 2025/0232693 A1
(43) Pub. Date: Jul. 17, 2025

(54) Techniques and Apparatuses for Label Positioning

(71) Applicant: HellermannTyton Corporation, Milwaukee, WI (US)

(72) Inventor: Todd Fries, Waukesha, WI (US)

(21) Appl. No.: 18/932,898

(22) Filed: Oct. 31, 2024

Related U.S. Application Data
(60) Provisional application No. 63/620,438, filed on Jan. 12, 2024.

(51) Int. Cl. G09F 3/00; G09F 3/02; G09F 3/10

(52) U.S. Cl. CPC G09F 3/0295; G09F 3/0288; G09F 3/10; G09F 2003/0208; G09F 2003/0226; G09F 2003/0241; G09F 2003/0264; G09F 3/0297

(57) ABSTRACT

Disclosed are self-laminating labels that are configured to be wrapped around an elongated article. In aspects, a self-laminating label includes a transparent body portion. The body portion includes a first end opposite a second end and a top side opposite a bottom side. The body portion includes a tab proximal to and extending from the first end. The tab configured for repositionable connection to a surface of the article. The body portion includes an overlay portion distal the first end and a printable portion proximal the first end and between the tab and the overlay portion. The printable portion is configured to be marked with indicia. The body portion further includes an adhesive coating on the bottom side. The overlay portion is configured to wrap over at least one of the tab or the printable portion.

### BACKGROUND

Identification labels are frequently affixed to articles (e.g., elongated objects, wires, cables, hoses, tubing, fiber optics, conduits, bundles thereof). An identification label provides information (e.g., indicia) that may be useful in the event that the system that includes the article requires service, repair, or maintenance. For example, an identification label may provide information that a wire bundle relates to, that identifies what functions a bundle of cables controls, identifies an origin or destination of a wire, identifies a wire type, identifies circuits, and the like. Identification labels may prevent misconnections, improve efficiency and accuracy, reduce risks of errors, and make it easier to troubleshoot issues. In some cases, identification labels are used for safety purposes. For example, identification labels may be used to identify battery wires and other high-voltage wires for emergency personnel (e.g., firefighters and paramedics).

Identification labels for such use commonly have an adhesive inner surface and an opposing outer surface (e.g., paper, vinyl, polyester), with the adhesive inner surface carried by (e.g., covered by) a removable carrier sheet before installation. In some cases, during the manufacturing process of the identification label, a thermal-transfer printable area is flexographically printed onto the outer surface of the label. This outer surface may be further printable (e.g., with indicia or other identifying information) by an operator, enabling the operator to use a thermal-transfer printer to print variable data (e.g., a wire number) onto the printable area of the label. Because the printable area is opaque (e.g., white), it can contrast nicely with thermally printed ink (e.g., black ink) and the color of the wire will not interfere with the readability of the label.

One type of such an identification label is a “self-laminating” label. A self-laminating label includes a clear protective layer that is configured to be wrapped around the article and adhere to the outer surface of the label to protect the information on the label from dust, dirt, abrasion, and other elements that might degrade the printed data on the label. For example, once the outer surface of the label is applied to the article, the clear protective layer may be wrapped around the article over the outer surface, thereby over-laminating and protecting the indicia on the label.

### SUMMARY

This document describes techniques and apparatuses for label positioning.

In some aspects, the techniques described herein relate to a label configured to wrap around an article, the label including: a transparent body portion, the transparent body portion including: a first end opposite a second end; a top side opposite a bottom side; a tab proximal the first end, the tab configured to reposition to connect to a surface of the article; an overlay portion distal the first end; and a printable portion proximal the first end and between the tab and the overlay portion, the printable portion configured to be marked with a first indicia; and an adhesive coating on the bottom side of the transparent body portion, the overlay portion configured to wrap over a wrap portion of the label.

In some aspects, the techniques described herein relate to a label configured to wrap around an article, the label including: a transparent body portion, the transparent body portion including: a first end, the first end of the transparent body portion defining a leading edge; a second end, the second end opposite the first end; a top side opposite a bottom side, the top side including: a tab extending from the first end, the tab configured to reposition to connect to a surface of the article, the tab including: a pivot point defined in the tab; an overlay portion distal the first end; and a printable portion proximal the first end and between the tab and the overlay portion, the printable portion configured to be marked with a first indicia; and a repositionable adhesive coating on the bottom side of the transparent body portion, the overlay portion configured to wrap over a wrap portion of the label, the label configured to pivot about the pivot point before the overlay portion is wrapped over the wrap portion, the repositionable connection of the tab to the surface of the article configured to permit rotation of the label at the tab from an initial position to an aligned position, and in the aligned position the leading edge of the transparent body portion is visually aligned with a longitudinal axis of the article.

In some aspects, the techniques described herein relate to a self-laminating label configured to be wrapped around an article, the self-laminating label including: a transparent body portion, the transparent body portion including: a first end opposite a second end; a top side opposite a bottom side; a tab proximal the first end, the tab configured for repositionable connection to a surface of the article; an overlay portion distal the first end; and a printable portion proximal the first end and between the tab and the overlay portion, the printable portion configured to be marked with a first indicia; and an adhesive coating on the bottom side of the transparent body portion, wherein the overlay portion is configured to wrap over at least one of the tab or the printable portion.

In some aspects, the techniques described herein relate to a self-laminating label configured to be wrapped around an article, the self-laminating label including: a transparent body portion, the transparent body portion including: a first end, the first end of the transparent body portion defining a leading edge; a second end, the second end opposite the first end; a top side opposite a bottom side, the top side including: a tab extending from the first end, the tab configured for repositionable connection to a surface of the article, the tab including: a pivot point defined in the tab; an overlay portion distal the first end; and a printable portion proximal the first end and between the tab and the overlay portion, the printable portion configured to be marked with a first indicia; and a repositionable adhesive coating on the bottom side of the transparent body portion, wherein the overlay portion is configured to wrap over at least one of the tab or the printable portion, wherein the self-laminating label is configured to pivot about the pivot point before the overlay portion is wrapped over at least one of the tab or the printable portion, wherein the repositionable connection of the tab to the surface of the article is configured to permit rotation of the self-laminating label at the tab from an initial position to an aligned position, and wherein in the aligned position the leading edge of the transparent body portion is visually aligned with a longitudinal axis of the article.

In some aspects, the techniques described herein relate to a self-laminating label configured to be wrapped around an article, the self-laminating label including: a transparent body portion, the transparent body portion further including: a first end, the first end of the transparent body portion defining a leading edge; a second end, the second end opposite the first end; a longitudinally extending axis that extends from the first end to the second end, the longitudinally extending axis defining a centerline; a top side opposite a bottom side, the top side including: an arc-shaped tab extending from the first end, the tab configured for repositionable connection to a surface of the article, the tab including: a pivot point defined in the tab on the centerline; an overlay portion distal the first end; and a printable portion proximal the first end and between the tab and the overlay portion, the printable portion configured to be marked with a first indicia; and a repositionable adhesive coating on the bottom side of the transparent body portion; and a removable carrier sheet disposed in contact with the repositionable adhesive coating, the carrier sheet configured to be removed from the repositionable adhesive coating, wherein the overlay portion is configured to wrap over at least one of the tab or the printable portion, wherein the self-laminating label is configured to pivot about the pivot point before the overlay portion is wrapped over at least one of the tab or the printable portion, wherein the repositionable connection of the tab to the surface of the article is configured to permit rotation of the self-laminating label at the tab from an initial position to an aligned position, wherein the tab is configured for repositionable connection to the surface of the article to enable the self-laminating label to be temporarily applied to the article and repositioned with or without removing the self-laminating label from the article and before the printable portion and the overlay portion are applied to the article, and wherein in the aligned position the leading edge of the transparent body portion is visually aligned with a longitudinal axis of the article.

This Summary is provided to introduce simplified concepts of techniques and apparatuses for label positioning, which are further described below in the Detailed Description and are illustrated in the Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of techniques and apparatuses for label positioning are described with reference to the following Drawings, in which the use the same numbers in different instances may indicate like features and/or components.

FIG. 1 is a perspective, environmental view of a first label applied on an article.

FIG. 2 is a plan view of the first label adhered to a carrier sheet.

FIG. 3 is a cross-sectional view along lines 3-3 of FIG. 2.

FIG. 4A is a first illustration of an example label application sequence.

FIG. 4B is a second illustration in the example label application sequence of FIG. 4A.

FIG. 4C is a third illustration in the example label application sequence of FIG. 4A.

FIG. 4D is a fourth illustration in the example label application sequence of FIG. 4A.

FIG. 5A is a plan view of a second label.

FIG. 5B is a plan view of a third label.

FIG. 5C is a plan view of a fourth label.

### DETAILED DESCRIPTION

This document describes techniques and apparatuses for label positioning. The techniques and apparatuses include improved labels, for example, self-laminating labels, which have a pivotably positionable tab configured for positioning on an article (e.g., wires, cables, hoses, tubing, fiber optics, conduits, bundles thereof). The article may be an elongated article.

In an aspect, the label includes a body portion. The body portion includes a first end opposite a second end and a top side opposite a bottom side. The body portion includes a tab that is proximal to and extends from (e.g., connects to, attaches to) the first end. The body portion further includes a printable portion and an overlay portion. In some aspects, the body portion may not include a printable portion. The body portion includes an adhesive portion (e.g., an adhesive coating) on the bottom side that is carried by a removable carrier sheet before use. The printable portion connects to the tab and is configured to be wrapped around the article and adhered to an outer surface of the tab. At least a portion of the body portion may include a clear protective layer (e.g., transparent polyvinyl chloride (vinyl), polyester, polypropylene, polyethylene, and the like) that is configured to be wrapped around the article and adhere to an outer surface of the label (e.g., an outer surface of the tab and/or an outer surface of the overlay portion) to protect indicia on the printable portion of the body portion from dust, dirt, abrasion and other elements that might degrade the information. Once the tab and the printable portion are applied to the article, the overlay portion may be wrapped around the article over a wrap portion of the label, for example, the outer surfaces of the tab and/or printable portion, thereby over-laminating and protecting the indicia on the label.

The tab is configured to enable an operator to quickly adjust the placement and position of the label on the article before the rest of the body portion (e.g., printable portion, overlay portion) is wrapped over the tab. For example, the tab can be adhered to the article and the label rotated, while adhered to the article, relative to the tab until a leading edge of the body portion is aligned with a longitudinal axis (A) of the article. Upon such alignment, the body portion can then be wrapped around the tab and the article to form a wrapped label. In aspects, this process may include an opaque printable portion of the body portion wrapped around the article, followed by a transparent overlay portion of the body portion wrapped around the article to over-laminate and protect indicia on the opaque printable portion of the label. In this way, the time required to properly hand apply a label to an article can be decreased.

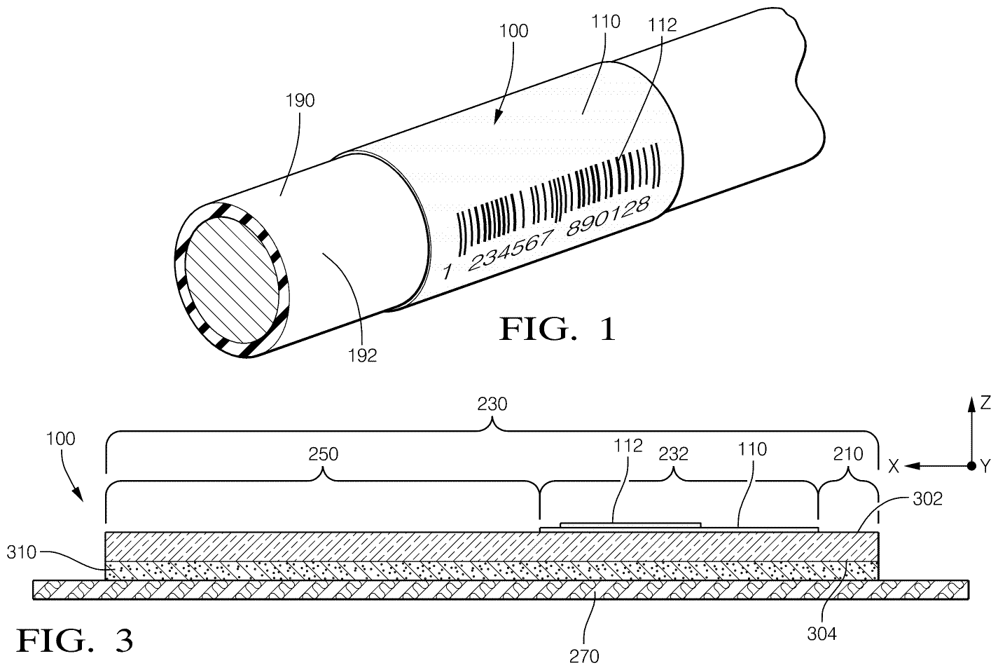

A first aspect of a label of the present disclosure is illustrated in FIGS. 1-4D. In FIG. 1, a label 100 is illustrated as installed on an article 190. In this figure, the article 190 is an elongated wire and the label 100 is applied to (e.g., wrapped around) an outer surface 192 (e.g., insulation) of the article 190 to form a wrapped label. Information (e.g., first indicia 110, second indicia 112) is provided on the label 100. This information may include, for example, text, symbols, machine-readable codes (e.g., barcodes), and the like. In aspects, the label 100 is a self-laminating label that includes a transparent overlay portion that covers and protects the information provided on the label.

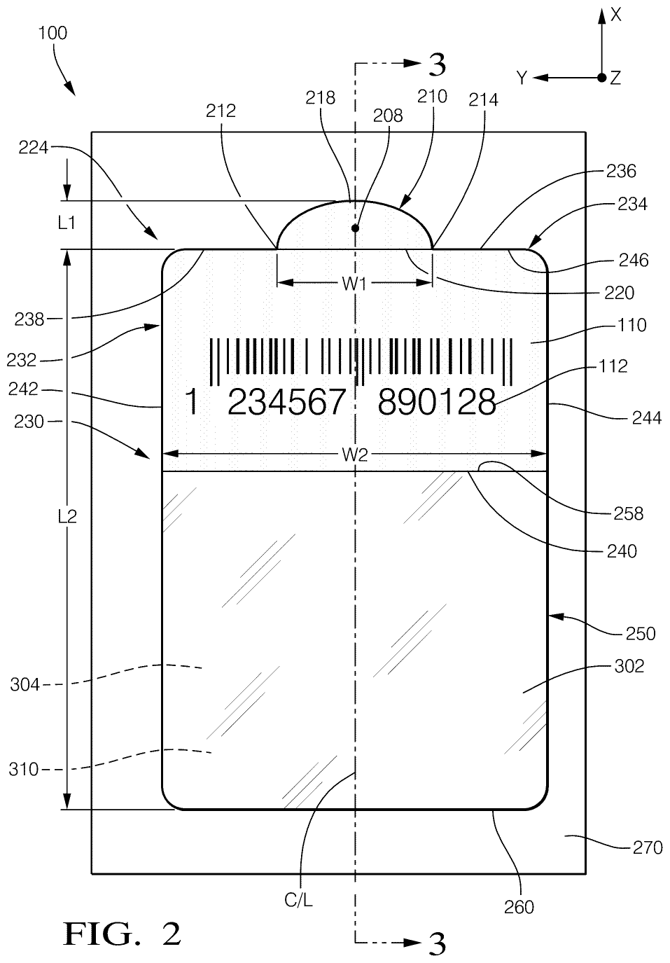

FIG. 2 is a plan view of the label 100 of FIG. 1, illustrated positioned on a carrier sheet 270. The carrier sheet 270 may be a removable carrier strip. FIG. 3 is a cross-sectional view of the aspect of FIG. 2 along lines 3-3. The carrier sheet 270 is disposed along an adhesive coating 310 provided on one or more bottom surfaces of the label 100. The carrier sheet 270 may include one or more of a silicone coated paper liner, a paper carrier, a removable liner, a backing layer, a wax sheet, and the like. Although not illustrated, the label 100 may be provided along with other labels in a strip or on a roll of labels. In FIG. 2, the label 100 is illustrated as temporarily affixed to the carrier sheet 270 (e.g., paper carrier, removable liner, backing layer, wax sheet). The carrier sheet 270 serves to protect the adhesive coating 310 before installation. The adhesive coating 310 located on a bottom side 304 of the body portion, as described further below. The adhesive coating 310 of the label 100 may be temporarily adhered to the carrier sheet 270. In this way, the label 100 is configured to be peeled off or otherwise removed from the carrier sheet 270 to expose the adhesive side of the label 100.

While FIGS. 2 and 3 illustrate a single label, one or more labels in one or more rows may be provided on the carrier sheet 270, which may be provided in one or more strips or sheets. The adhesive coating 310 of the label 100 may be positioned on the carrier sheet 270 before and/or during the printing of indicia on the label 100. The carrier sheet 270 is configured to be removed from the label 100 to expose the adhesive coating 310. After removal of the carrier sheet 270, the adhesive-coated side (e.g., the bottom side 304) of the label 100 may be applied an article 190 to be labeled and the label 100 wrapped around the article 190. Removal (e.g., delamination) of the label 100 from the carrier sheet 270 to expose the adhesive coating 310 may include one or more of bending the label or a portion thereof, folding the label or a portion thereof, rolling the label or a portion thereof, an operator inserting a fingernail under the tab, auto-dispensation of the label by a machine, and/or other methods.

In this aspect, the label 100 is a self-laminating label that includes a body portion 230. The body portion 230 may include an overlay portion 250, a printable portion 232, and a tab 210 that extends from (e.g., connects to, attaches to) the printable portion 232. The tab 210, printable portion 232, and overlay portion 250 may be positioned end-to-end along a length of the label 100.

The label 100 may include a top side 302 and a bottom side 304. The top side 302 is outwardly facing (e.g., faces away from the carrier sheet 270 when the label 100 is disposed on the carrier sheet 270) and the bottom side 304 is inwardly facing (e.g., faces the carrier sheet 270 when the label 100 is disposed on the carrier sheet 270). The bottom side 304 includes the adhesive coating 310. The adhesive coating 310 may be carried by the carrier sheet 270 before the label 100, or a portion thereof, is removed from the carrier sheet 270. The bottom side 304 is configured to contact the outer surface 192 of the article 190.

The printable portion 232 is configured to receive indicia (e.g., first indicia 110, second indicia 112), for example, on the top side 302. While in aspects, the indicia may be ink printed on the printable portion 232, for illustration purposes (e.g., in FIG. 3), the first indicia 110 and the second indicia 112 are illustrated schematically. The printable portion 232 may include a thermal-transfer printable area that is flexographically printed (e.g., during the manufacture of the label, before application of the label) by application of a first indicia 110, which renders at least a portion of the printable portion 232 opaque (e.g., white). The flexographic printing of the first indicia 110 may extend onto the tab 210 to render at least a portion of the tab 210 opaque. Second indicia 112 (e.g., in black or a contrasting color to the first indicia 110) may be printed on the printable portion 232, for example on top of the first indicia 110, as schematically illustrated in FIG. 3. A standard thermal-transfer printer, an ink jet printer using liquid ink, a “laser-beam” printer using toner, and the like, not illustrated, may be used to print the indicia on the label 100 in the printable area.

One or more adhesives may be disposed or otherwise applied to the bottom side 304 of the label 100, for example in an adhesive coating 310 on the bottom side 304 of the label 100. Examples of adhesives that may be used for the adhesive coating include repositionable adhesives and permanent adhesives. As used herein, the term “repositionable adhesive” conventionally denotes an adhesive (e.g., a removable adhesive, a pressure-sensitive adhesive) having an adhesive strength (e.g., tack, stickiness) that is sufficient for immediate adhesion on loading but enables the label to be repositioned (e.g., rotated) to other positions. As used herein, the term “permanent adhesive” conventionally denotes an adhesive having an adhesive strength (e.g., tack, stickiness) intended to strongly bond together two components such that they will not separate in normal use. A permanent adhesive may enable the label to be repositioned to other positions before a final, permanent, bond is made. In this context, a permanent adhesive may be repositionable initially after a first tack and may reach a full (e.g., permanent) bond over a time period (e.g., after a number of hours). The adhesive coating 310 may form a strong bond with the bottom side 304 of the label 100 but only a weak bond with the carrier sheet 270.

The tab 210 is configured to position the label 100 on an article (e.g., article 190 illustrated in FIG. 1). The tab 210 extends from the printable portion 232. In the aspect illustrated in FIG. 2, the tab 210 is centered on a first end 236 of the body portion 230 and is located on the first end 236 between a first side 242 and a second side 244 of the body portion 230. The first end 236 may be positioned orthogonal to the first side 242 and the second side 244. The tab 210 has a first end 218 opposite a second end 220, and the second end 220 connects with and extends from the first end 236. The tab 210 has a first side 212 opposite a second side 214. In aspects, the first side 212 is spaced apart from the first side 242 and the second side 214 is spaced apart from the second side 244. A first width (W1) of the tab 210 can be defined between the first side 212 and the second side 214. The label 100 has a generally longitudinally extending axis (e.g., centerline (C/L)) that extends from the first end 218 to the second end 260 along the X-axis. The first side 242 and the second side 244 may be equally spaced apart from the centerline. In aspects, the tab 210 is centered on the centerline.

For clarity, a Cartesian coordinate system is used and is labeled in FIGS. 2-4C. The coordinate system includes three dimensions, namely, an X-axis, a Y-axis, and a Z-axis. Each of the three axes is orthogonal to the other two axes. The X-axis and the Y-axis define a horizontal plane, with the Z-axis in a vertical direction. While the origin of the coordinate system may be placed at any point on or near the components of the label, for the purposes of description, the axes of the coordinate system are always disposed along the same directions from figure to figure, unless indicated otherwise. In some examples, reference may be made to dimensions, angles, directions, relative positions, and/or movements associated with one or more components of the label with respect to the coordinate system. For instance, the length of a label may be defined as a dimension along the X-axis, the width of the label may be defined as a dimension along the Y-axis, and a thickness of the label may be defined as a dimension along the Z-axis of the coordinate system.

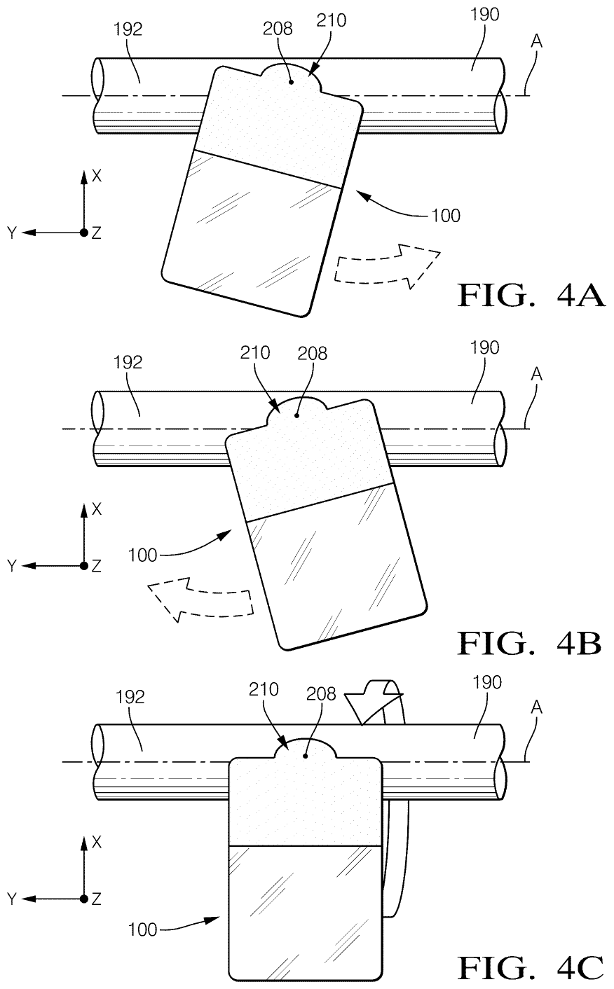

In the aspect illustrated in FIGS. 2-4C, the tab 210 extends from the first end 236 (e.g., from a leading edge 234) of the body portion 230 and enables the label 100 to be initially applied to the article 190. The tab 210 enables the label 100 to be repositioned on the article 190 without removing the label 100 from the article 190, with the repositioning taking place before the printable portion 232 is applied to the article 190 and/or before the overlay portion 250 is applied to the article 190. To express it another way, the tab 210 is pivotably positionable and configured to enable an operator to quickly adjust the placement and position of the label 100 on the article 190 before the rest of the body portion 230 (e.g., printable portion 232, overlay portion 250) is wrapped over the tab 210 and the article 190, for example, as illustrated in FIGS. 4A, 4B, 4C, and 4D. In other aspects, the tab 210 enables the label 100 to be removed from the article 190 and then reapplied to the article 190.

In this example, the bottom side 304 of the tab 210 is configured to be initially adhered at a first position to the outer surface 192 of the article 190. The tab 210 defines a pivot point 208 for the label 100 relative to the article 190. The pivot point 208 can be located anywhere within the tab 210 and the origin of the coordinate system may be placed at any point on or near the pivot point 208. In this way, the label 100 may be rotated about the origin of the horizontal plane (e.g., about the XOY plane). After the tab 210 is adhered to the outer surface 192 of the article 190, the label 100 may be pivoted relative to the pivot point 208 in a first rotational direction (illustrated in FIG. 4A) and/or in a second rotational direction (illustrated in FIG. 4B) until a leading edge 234 of the body portion 230 is visually aligned with a longitudinal axis (A) of the article 190, as illustrated in FIG. 4C. In aspects, the operator may apply a downward pressure to the tab 210 at the pivot point 208 during the rotational process to maintain the tab 210 on the outer surface 192 of the article 190. Upon the determination of a visual alignment of the leading edge 234 with the longitudinal axis, the operator may then wrap the rest of the body portion 230 to over-laminate the tab 210 and attach the tab 210 to the article 190, as illustrated in FIG. 4D.

In aspects, a portion of the body portion 230 (e.g., the overlay portion 250) overlaminates and protects indicia (e.g., first indicia 110, second indicia 112) printed on the printable portion 232 of the label 100. In one example, wrapping the body portion 230 to over-laminate the tab 210 includes wrapping the printable portion 232 of the body portion 230 around the article 190 and over the tab 210, followed by wrapping the overlay portion 250 (e.g., clear protective layer) of the body portion 230 over the tab 210 and/or the printable portion 232. In this way, the time required to properly hand apply a label to an article may be decreased. The wrapping of the body portion 230 (e.g., the printable portion 232 and/or the overlay portion 250) around the article 190 and over the tab 210 may fix the position of the tab 210 on the article 190. In this way, further movement (e.g., pivoting) of the tab 210 relative to the article 190 is prevented.

Operators frequently find that some articles are more difficult to accurately apply labels to than others. For example, small-diameter conductors (e.g., small gauge wires) tend to not be perfectly straight, which can arise from a number of reasons, including the elasticity of the material of the conductor, drawing processes during the manufacture of the conductor, the coiling of the conductor onto a spool, the uncoiling of the conductor from the spool, and the like. This unstraightness can make it difficult for an operator to maintain a consistent alignment as the label is wrapped around the conductor, frequently resulting in a distal end of the label misaligned (e.g., offset, applied at an angle) on the article relative to a proximal end of the label. The utilization of a label (e.g., label 100) that includes a tab (e.g., tab 210) configured for pivotable positioning may permit an operator to more cleanly and professionally apply a label to a small-diameter conductor. In this way, the time to properly hand apply a label to an article may be decreased and consistency in label application is increased.

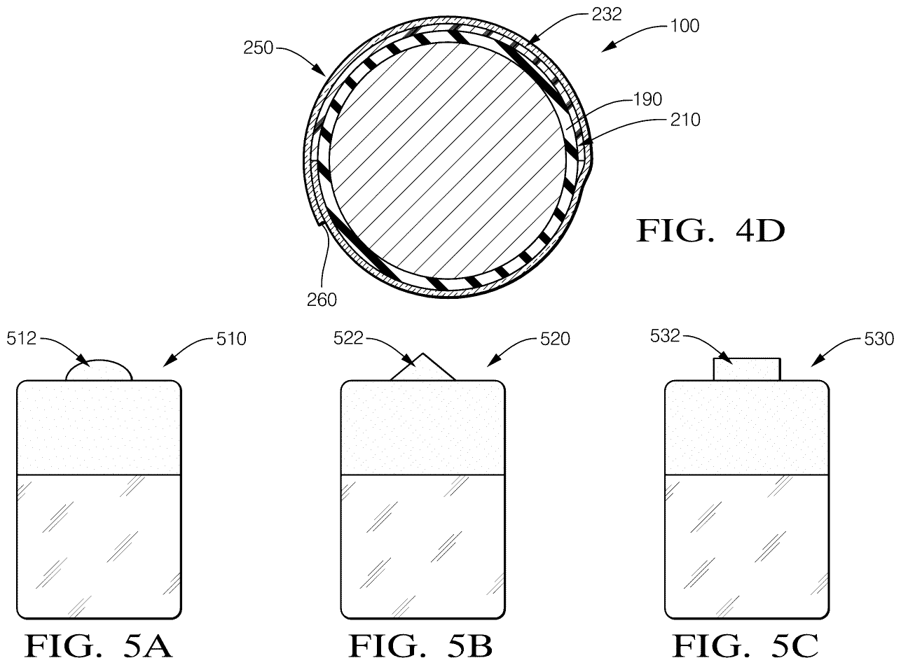

In FIG. 2, the tab 210 is illustrated as an arc-shaped (e.g., semi-circular) tab. In other aspects, a tab may have another shape, including, but not limited to, triangular shapes, polygonal shapes, and other shapes. For example, FIGS. 5A-5C are plan views of additional aspects of labels. In label 510 illustrated in FIG. 5A, the tab 512 has a second arc shape. In label 520 illustrated in FIG. 5B, the tab 522 is triangular-shaped. In label 530 illustrated in FIG. 5C, the tab 532 is polygonal-shaped.

In the aspect illustrated in FIGS. 2 and 3, the body portion 230 includes the printable portion 232 and the overlay portion 250. The printable portion 232 is configured to receive indicia (e.g., first indicia 110, second indicia 112). For example, a thermal-transfer printer can be utilized to print indicia (e.g., variable data, a wire number) onto the printable portion 232 of the label 100. In aspects, at least a portion of the printable portion 232 is opaque.

The printable portion 232 is further configured to be wrapped around an article. For example, in aspects, a portion of the printable portion 232 may be configured to wrap around the article (e.g., article 190) and cover the tab 210, which is adhered to the article, for example, as illustrated in FIGS. 4A-4D and described below.

In the aspect illustrated in FIG. 2, the tab 210 connects at the printable portion 232. In other aspects, the printable portion 232 may be spaced apart from the tab 210. The printable portion 232 includes a first side 242 opposite a second side 244, the first and second sides defining a second width (W2) therebetween. In the aspect illustrated in FIG. 2, the second width (W2) is also the width of the overlay portion 250. In the aspect illustrated in FIG. 2, the second width (W2) is more than twice the width of the first width (W1). To say it another way, the width of the tab 210 is less than half the width of the printable portion 232. The width of the tab 210 being less than the width of the printable portion 232 may facilitate an easier removal of the label 100 from a carrier sheet (e.g., carrier sheet 270) that carries the label 100. For example, it may be easier for an operator to flex the carrier sheet at the tab 210 or otherwise manipulate the tab 210 and release the tab 210 from the carrier sheet, thereby facilitating the detachment of the label 100 from the carrier sheet. In this way, an operator is able to perform label application work more quickly. In other aspects, the second width (W2) may be equal to or less than twice the width of the first width (W1). To say it another way, the width of the tab 210 may be equal to or more than half the width of the printable portion 232.

The measurements and dimensions of a label disclosed herein may vary between implementations, and any measurements provided herein are merely examples. In one example, the first width (W1) is 0.4 in. (10.16 mm), the second width (W2) is 1.125 in. (28.575 mm), a length (L1) of the tab 210 is 0.125 in. (3.175 mm), and a length (L2) of the body portion 230 is 1.5625 in. (39.6875 mm).

The printable portion 232 further includes the first end 236 opposite a second end 240. The first end 236 may include one or more portions (e.g., a first end portion 238 and a second end portion 246 located on opposite sides of the tab 210). The first end 236 (e.g., first end portion 238 and second end portion 246) may define a leading edge 234 that is configured to be utilized to align the label 100 on the article 190. In this way, the tab 210 is configured to enable an operator to quickly adjust the placement and position of the label 100 on the article 190 before the rest of the body portion 230 (e.g., printable portion 232, overlay portion 250) of the label 100 is wrapped over the tab 210, as illustrated in FIGS. 4A-4D. For example, the tab 210 can be adhered to the article 190 and the label 100 rotated relative to the tab 210 until the leading edge 234 of the body portion 230 is aligned with a longitudinal axis (A) of the article 190. Upon such alignment, the printable portion 232 can be wrapped around the article 190, followed by the overlay portion 250 to over-laminate and protect indicia on the label 100. In some cases, at least one of the printable portion 232 or the overlay portion 250 covers the tab 210 when wrapped. In these ways, in some cases, the time to properly hand apply a label to an article is decreased. In other example, the tab 210 can be initially adhered to the article 190 and then removed and reapplied to the article 190 by the operator.

The material of the body portion 230 may include paper, transparent polyvinyl chloride (vinyl), polyester, polypropylene, polyethylene, and the like. In aspects where the material of the body portion 230 is a transparent material (e.g., transparent polyvinyl chloride (vinyl)), the overlay portion 250 operates as a clear protective layer that is configured to be wrapped around the article 190 and adhere to the top side 302 of the label 100. In this way, the overlay portion 250 may protect information (e.g., indicia) printed on the printable portion 232 from dust, dirt, abrasion, and other elements that might degrade the information. For example, once the tab 210 and printable portion 232 are applied to the article 190, the overlay portion 250 may be wrapped around the article 190 over a wrap portion 224 of the label, for example, the outer surfaces (e.g., top side 302) of the tab 210 and/or printable portion 232, thereby over-laminating and protecting the indicia on the label 100. The overlay portion 250 further includes a first end 258 opposite a second end 260. In the aspect illustrated in FIG. 2, the first end 258 connects to the second end 240 of the printable portion 232.

The disclosed labels are configured to enable an operator to utilize a tab to adjust the placement and position of a label on an article before a body portion (e.g., printable portion, overlay portion) of the label is wrapped over the tab. For example, the tab can be adhered to the article and the label rotated relative to the tab until a leading edge of the body portion is aligned with the longitudinal axis (A) of the article. Upon such alignment, the printable portion can be wrapped around the article, followed by the overlay portion to over-laminate and protect the indicia on the label. In this way, in some cases, the time to properly hand apply a label to an article is decreased.

In aspects, the tab 210 is further configured to facilitate an easier removal of a label from a carrier sheet that carries the label. For example, an operator may flex the carrier sheet at the tab 210 or otherwise manipulate the tab 210 and release the tab 210 from the carrier sheet, thereby facilitating the detachment of the label from the carrier sheet. In this way, an operator is able to perform label application work more quickly.

In the figures, the labels (e.g., label 100, label 510, label 520, label 530) are illustrated as having rounded corners. In other aspects, one or more of the corners of the labels may not be rounded.

Indicia may be present on the tab, for example, as illustrated in FIGS. 5A-5C. In a first example, as described above, the printing of the first indicia may extend onto the tab to render at least a portion of the tab opaque. In another example, indicia on the tab may have a color (e.g., a metallic color, a reflective color, a different color than the color of the article) that is beneficial in low lighting. In another example, the tab may include a different texture than the rest of the label, for example through the application of a rough surface additive (e.g., a lattice pattern, a dot matrix pattern, or other pattern on a heated punch around the tab feature), a textured tab paint, and the like. In another example, the top side of the label, at the tab, may include an coating (e.g., an adhesive coating, a tacky coating, a high friction rubber-like coating) that is configured to improve visibility and/or to make it easier for an operator to grasp the tab during the application process, which may be beneficial in low lighting conditions and/or wet, dusty, and/or oily environments.

In other aspects, the adhesive coating may not be present on the bottom side of the label at the tab. In this way, it may be easier for an operator to remove the tab (and/or label) from the carrier sheet.

This disclosure also describes example methods, which may operate separately or together in whole or in part. The disclosed labels are configured for use in an improved label application process. The label application processes may prevent contamination of the printable portion of the label by the operator (e.g., prevents the operator from inadvertently smudging indicia on the printable portion during the application process, prevents oils on the skin of the operator from degrading the integrity of the adhesive coating). In one example process, a user frees the tab from the carrier sheet and peels the label off the carrier sheet without touching the printable portion of the label. The user then uses a finger to apply the tab of the label to the article. The user holds the finger on the tab and adjusts the placement and position of the label on the article (e.g., by rotating the label relative to the tab until a leading edge of the body portion is aligned with a longitudinal axis of the article). Once aligned, the user wraps the body portion (e.g., printable portion, overlay portion) of the label over the tab and around the article, without physically touching (or minimally touching) the printable portion of the label. In this way, the indicia on the printable portion are protected from degradation.

Also disclosed are methods of wrapping a self-laminating label on an elongated article (e.g., a wire). In one aspect, a self-laminating label is provided that includes a body portion. The label includes a bottom side on which an adhesive coating is disposed. The body portion includes a first end opposite a second end, a printable portion proximal to the first end, a transparent overlay portion distal the first end, and a tab extending from the printable portion. The first end of the body portion defines a leading edge. The printable portion is configured to be marked with indicia. The tab is configured for repositionable connection to the surface of the elongated article. The tab includes a pivot point. The method further includes applying, via the adhesive coating, the tab to an outer surface of the elongated article and rotating the label at the pivot point from an initial position to an aligned position, wherein in the aligned position the leading edge is visually aligned with the longitudinal axis of the article. Upon determining a visual alignment, the rest of the body portion is wrapped over at least one of the tab or the opaque printable portion to form a wrapped label.

A second aspect of a method of wrapping a self-laminating label on an elongated article includes providing a self-laminating label that includes a body portion with a tab. The body portion includes a first end opposite a second end, a printable portion proximal to the first end, a transparent overlay portion distal the first end, and a bottom side on which an adhesive coating is disposed. The first end defines a leading edge and the tab extends from the first end. The tab is configured for repositionable connection to the surface of the elongated article. The tab includes a pivot point. The method further includes applying a first indicia to the printable portion to render at least a portion of the printable portion opaque and applying a second indicia on top of at least a portion of the first indicia. The method further includes applying the tab via the adhesive coating to an outer surface of the elongated article and rotating the label at the pivot point from an initial position to an aligned position, wherein in the aligned position the leading edge is visually aligned with the longitudinal axis of the article. Upon determining a visual alignment, the rest of the body portion is wrapped over at least one of the tab or the printable portion to form a wrapped label. In aspects, the printable portion is transparent before the application of the first indicia.

Some additional examples of techniques and apparatuses for label positioning are as follows:

Example 1. A label configured to wrap around an article, the label comprising: a transparent body portion, the transparent body portion comprising: a first end opposite a second end; a top side opposite a bottom side; a tab proximal the first end, the tab configured to reposition to connect to a surface of the article; an overlay portion distal the first end; and a printable portion proximal the first end and between the tab and the overlay portion, the printable portion configured to be marked with a first indicia; and an adhesive coating on the bottom side of the transparent body portion, the overlay portion configured to wrap over a wrap portion of the label.

Example 2. The label of Example 1, wherein the wrap portion of the label further comprises at least one of the tab or the printable portion.

Example 3. The label of Example 2, further comprising: a pivot point defined on the tab, wherein the label is configured to pivot about the pivot point before the overlay portion is wrapped over at least one of the tab or the printable portion.

Example 4. The label of Example 3, wherein the transparent body portion has a longitudinally extending axis that extends from the first end to the second end, the longitudinally extending axis defining a centerline, and wherein the pivot point is located on the centerline.

Example 5. The label of Example 1, wherein the first end of the transparent body portion defines a leading edge, wherein the repositionable connection of the tab to the surface of the article is configured to permit rotation of the label at the tab from an initial position to an aligned position, and wherein in the aligned position the leading edge of the transparent body portion is visually aligned with a longitudinal axis of the article.

Example 6. The label of Example 1, wherein the tab is centered on the first end of the transparent body portion.

Example 7. The label of Example 1, wherein the transparent body portion has a longitudinally extending axis that extends from the first end to the second end, the longitudinally extending axis defining a centerline, wherein the tab has a first side opposite a second side defining a width therebetween, and wherein the width of the tab is centered on the first end of the transparent body portion at the centerline.

Example 8. The label of Example 1, wherein the tab has a first side opposite a second side defining a width therebetween, and wherein the first and second sides of the tab are spaced apart from the respective first and second ends of the transparent body portion.

Example 9. The label of Example 1, wherein the tab has a first side opposite a second side defining a width therebetween, and wherein the width of the tab is less than half a width of the printable portion of the label.

Example 10. The label of Example 1, wherein the adhesive coating is repositionable.

Example 11. The label of Example 1, wherein the printable portion is marked with the first indicia, and wherein the first indicia renders at least a portion of the printable portion opaque, and wherein the printable portion is further marked with a second indicia on top of the first indicia.

Example 12. The label of Example 1, wherein the printable portion is marked with the first indicia, and wherein the first indicia renders at least a portion of the printable portion opaque.

Example 13. The label of Example 1, wherein the printable portion is further marked with a second indicia on top of the first indicia.

Example 14. The label of Example 1, wherein the tab is configured to reposition to connect to the surface of the article to enable the label to be temporarily applied to the article and repositioned without removing the label from the article and before the printable portion and the overlay portion are applied to the article.

Example 15. The label of Example 1, wherein the tab is at least one of arc-shaped, triangular-shaped, or polygonal-shaped.

Example 16. The label of Example 1, further comprising: a removable carrier sheet disposed in contact with the adhesive coating, the removable carrier sheet configured to be removed from the adhesive coating.

Example 17. A label configured to wrap around an article, the label comprising: a transparent body portion, the transparent body portion comprising: a first end, the first end of the transparent body portion defining a leading edge; a second end, the second end opposite the first end; a top side opposite a bottom side, the top side comprising: a tab extending from the first end, the tab configured to reposition to connect to a surface of the article, the tab comprising: a pivot point defined in the tab; an overlay portion distal the first end; and a printable portion proximal the first end and between the tab and the overlay portion, the printable portion configured to be marked with a first indicia; and a repositionable adhesive coating on the bottom side of the transparent body portion, the overlay portion configured to wrap over a wrap portion of the label, the label configured to pivot about the pivot point before the overlay portion is wrapped over the wrap portion, the repositionable connection of the tab to the surface of the article configured to permit rotation of the label at the tab from an initial position to an aligned position, and in the aligned position the leading edge of the transparent body portion is visually aligned with a longitudinal axis of the article.

Example 18. The label of Example 17, wherein the wrap portion of the label comprises at least one of the tab or the printable portion.

Example 19. The label of Example 17, wherein the tab is at least one of arc-shaped, triangular-shaped, or polygonal-shaped.

Example 20. The label of Example 17, further comprising: a removable carrier sheet disposed in contact with the repositionable adhesive coating, the removable carrier sheet configured to be removed from the repositionable adhesive coating.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

Although implementations of techniques and apparatuses for label positioning have been described in language specific to certain features and/or methods, the subject of the appended claims is not necessarily limited to the specific features or methods described. Rather, the specific features and methods are disclosed as example implementations of techniques and apparatuses for label positioning.

What is claimed is:

1. A label configured to wrap around an article, the label comprising:
a transparent body portion, the transparent body portion comprising:
a first end opposite a second end;
a top side opposite a bottom side;
a tab proximal the first end, the tab configured to reposition to connect to a surface of the article;
an overlay portion distal the first end; and
a printable portion proximal the first end and between the tab and the overlay portion, the printable portion configured to be marked with a first indicia; and
an adhesive coating on the bottom side of the transparent body portion, the overlay portion configured to wrap over a wrap portion of the label.

2. The label of claim 1, wherein the wrap portion of the label further comprises at least one of the tab or the printable portion.

3. The label of claim 2, further comprising:
a pivot point defined on the tab, wherein the label is configured to pivot about the pivot point before the overlay portion is wrapped over at least one of the tab or the printable portion.

4. The label of claim 3,
wherein the transparent body portion has a longitudinally extending axis that extends from the first end to the second end, the longitudinally extending axis defining a centerline, and
wherein the pivot point is located on the centerline.

5. The label of claim 1,
wherein the first end of the transparent body portion defines a leading edge,
wherein the repositionable connection of the tab to the surface of the article is configured to permit rotation of the label at the tab from an initial position to an aligned position, and
wherein in the aligned position the leading edge of the transparent body portion is visually aligned with a longitudinal axis of the article.

6. The label of claim 1, wherein the tab is centered on the first end of the transparent body portion.

7. The label of claim 1,
wherein the transparent body portion has a longitudinally extending axis that extends from the first end to the second end, the longitudinally extending axis defining a centerline,
wherein the tab has a first side opposite a second side defining a width therebetween, and
wherein the width of the tab is centered on the first end of the transparent body portion at the centerline.

8. The label of claim 1,
wherein the tab has a first side opposite a second side defining a width therebetween, and
wherein the first and second sides of the tab are spaced apart from the respective first and second ends of the transparent body portion.

9. The label of claim 1,
wherein the tab has a first side opposite a second side defining a width therebetween, and
wherein the width of the tab is less than half a width of the printable portion of the label.

10. The label of claim 1, wherein the adhesive coating is repositionable.

11. The label of claim 1,
wherein the printable portion is marked with the first indicia, and
wherein the first indicia renders at least a portion of the printable portion opaque, and
wherein the printable portion is further marked with a second indicia on top of the first indicia.

12. The label of claim 1,
wherein the printable portion is marked with the first indicia, and
wherein the first indicia renders at least a portion of the printable portion opaque.

13. The label of claim 1, wherein the printable portion is further marked with a second indicia on top of the first indicia.

14. The label of claim 1, wherein the tab is configured to reposition to connect to the surface of the article to enable the label to be temporarily applied to the article and repositioned without removing the label from the article and before the printable portion and the overlay portion are applied to the article.

15. The label of claim 1, wherein the tab is at least one of arc-shaped, triangular-shaped, or polygonal-shaped.

16. The label of claim 1, further comprising:
a removable carrier sheet disposed in contact with the adhesive coating, the removable carrier sheet configured to be removed from the adhesive coating.

17. A label configured to wrap around an article, the label comprising:
a transparent body portion, the transparent body portion comprising:
a first end, the first end of the transparent body portion defining a leading edge;
a second end, the second end opposite the first end;
a top side opposite a bottom side, the top side comprising:
a tab extending from the first end, the tab configured to reposition to connect to a surface of the article, the tab comprising:
a pivot point defined in the tab;
an overlay portion distal the first end; and
a printable portion proximal the first end and between the tab and the overlay portion, the printable portion configured to be marked with a first indicia; and
a repositionable adhesive coating on the bottom side of the transparent body portion,
the overlay portion configured to wrap over a wrap portion of the label,
the label configured to pivot about the pivot point before the overlay portion is wrapped over the wrap portion,
the repositionable connection of the tab to the surface of the article configured to permit rotation of the label at the tab from an initial position to an aligned position, and
in the aligned position the leading edge of the transparent body portion is visually aligned with a longitudinal axis of the article.

18. The label of claim 17, wherein the wrap portion of the label comprises at least one of the tab or the printable portion.

19. The label of claim 17, wherein the tab is at least one of arc-shaped, triangular-shaped, or polygonal-shaped.

20. The label of claim 17, further comprising:
a removable carrier sheet disposed in contact with the repositionable adhesive coating, the removable carrier sheet configured to be removed from the repositionable adhesive coating.
